(19) United States
(12) Patent Application Publication
(10) Pub. No.: US 2014/0274008 A1
(43) Pub. Date: Sep. 18, 2014

(54) SYSTEM AND METHOD OF OPERATING A SECONDARY MOBILE DEVICE

(71) Applicant: OnBeond, LLC, Santa Monica, CA (US)

(72) Inventor: Robert Olodort, Santa Monica, CA (US)

(73) Assignee: OnBeond, LLC, Santa Monica, CA (US)

(21) Appl. No.: 14/213,444

(22) Filed: Mar. 14, 2014

Related U.S. Application Data
(60) Provisional application No. 61/842,277, filed on Jul. 2, 2013.
(60) Provisional application No. 61/792,536, filed on Mar. 15, 2013.
(60) Provisional application No. 61/842,901, filed on Jul. 3, 2013.

(51) Int. Cl. H04M 3/54; H04W 4/16

(52) U.S. Cl. CPC H04M 3/54; H04W 4/16
USPC 455/417

(57) ABSTRACT

Using various embodiments, methods and systems for operating a secondary cellular telephone are described. The secondary cellular telephone, which is associated with subscriber ID account information of a primary cellular telephone, can be used to receive incoming calls or make outgoing calls. The secondary cellular telephone, in one embodiment, has its own telephone number, which is different from that of the primary cellular telephone. Incoming calls made to the primary cellular telephone number, by association with the subscriber ID account information of a primary cellular telephone, can be forwarded to the secondary cellular telephone. Similarly, with the association of the subscriber ID account information of the primary cellular telephone, outgoing calls made by the secondary cellular telephone can be spoofed with the primary cellular telephone number such that the receiver of the call would assume the call was made via the primary cellular telephone. Various other novel features, such as, finding the primary cellular telephone and remotely erasing data on the primary cellular telephone, by using the secondary cellular telephone are described herein.

This application claims the benefit, including the benefit of the filing dates, of the following U.S. Provisional Patent Applications: 61/842,277 (filed Jul. 2, 2013); 61/792,536 (filed Mar. 15, 2013); and 61/842,901 (filed Jul. 3, 2013); and all three of these provisional patent applications are incorporated herein by reference in their entirety.

### BACKGROUND OF THE INVENTION

Smartphones are increasingly becoming an important communication tool. In addition to voice communications, they allow texting, e-mail, web browsing, photography, video recording, music listening, navigation, calendars, address books, notifications, voice recognition, games and thousands of other applications. This year marks the first time that more people have access to the interne through smartphones and tablet computers than with desktop and laptop computers.

Because of the growing success of the smartphones, traditional landline telephone use is on the decline. The downside is that people are becoming more and more dependent on just one device—their smartphone. Thus, when a user's smartphone is lost, stolen, misplaced, has dead batteries, or is inconveniently located, for example, during an emergency, a huge inconvenience can occur.

### SUMMARY OF THE DESCRIPTION

The present disclosure describes systems and methods of operating a secondary cellular telephone. In one embodiment, a user purchases a service plan or subscription from a carrier or provider of a cellular telephone network which includes activation of at least a primary and a secondary cellular telephone. This subscription plan associates, in one embodiment, the secondary cellular telephone with the subscriber ID account information of the primary cellular telephone on the same carrier network. In addition, the user can provide permission to the carrier that, under certain conditions, all incoming calls to the primary cellular telephone number are automatically forwarded to the secondary cellular telephone, and/or all outgoing calls made from the secondary cellular telephone are “spoofed” so that the caller ID on the phone of the call receiving party (when calls are made using the secondary cellular telephone) indicates the same phone number and identity as that of the primary cellular telephone. This permission can be provided in the process of signing up or setting up of the subscription plan for communication services through the carrier's cellular telephone network. To trigger the described forwarding/spoofing operation, in one embodiment, the secondary phone could simply be turned on, perform the cellular registration process and connect to the network, thereby signaling the network that forwarding or spoofing or both forwarding and spoofing should be implemented. In another embodiment, the secondary cellular telephone can transmit explicit instructions as to when the cellular telephone network should implement the forwarding and/or spoofing operations.

In one embodiment, the secondary cellular telephone can be provided a unique permanent phone number at the time the user purchases a subscription plan with a carrier or other service provider. However, since the secondary cellular telephone may be used sporadically, a carrier may not want to tie up a single telephone number. Thus, in another embodiment, the carrier or provider of the cellular telephone network can assign a telephone number on demand; for example, each time the secondary cellular telephone registers and connects with the cellular telephone network, a telephone number is assigned, and the assigned telephone number can be different each time the secondary cellular telephone registers and connects with the cellular telephone network. In another embodiment, the secondary cellular telephone number could remain for a fixed period of time set by the carrier or the user (e.g., 24 hours). Since all calls appear to be made from or to the user's the primary cellular telephone number, there would be no concern about the secondary cellular telephone having a phone number that changes on occasion as the new number, in such an embodiment, would be transparent to the user and the recipient of any outgoing calls.

In another embodiment, the forwarding operation of incoming calls can include allowing both the primary and the secondary cellular telephones to ring at the same time during an incoming call. This simultaneous ringing might be useful if the primary cellular telephone is misplaced rather than stolen, or for other user preferences. In another embodiment, the secondary cellular telephone can be programmed to offer delayed ringing, in which the primary cellular telephone rings for a given number of rings (e.g., two rings), before the secondary cellular telephone rings. In yet another embodiment, the cellular telephone network can be configured to offer a delayed ringing capability by first ringing the primary cellular telephone for a given number of rings, before ringing the secondary cellular telephone (alone or simultaneously with the primary cellular telephone).

In one embodiment, the secondary cellular telephone is either integrated into a vehicle, such as an automobile, or is an add-on option of the vehicle or can be added as a plug-in capability of the vehicle. The secondary cellular telephone, when integrated into the vehicle, can be integrated into the vehicle at a factory location where the automobile is manufactured and assembled; in this case, when the original buyer first receives the vehicle, it already includes the secondary cellular telephone as a factory installed feature. The secondary cellular telephone, when added as an add-on option of the vehicle, can be added into the vehicle by a vehicle dealer at the time of purchase and/or delivery of the vehicle or be added afterwards by a dealer or service/repair facility. When the secondary cellular telephone is integrated into the vehicle or is an add-on option, the secondary cellular telephone uses one or more speakers built into the automobile and one or more microphones built into the vehicle so the secondary cellular telephone can operate in a hands-free manner. For example, the same speakers used in the vehicle for music and/or radio playback are used by the secondary cellular telephone, and the microphones used for the vehicle's speech recognition system (e.g. for voice control of the radio or navigation system) are also used by the secondary cellular telephone. Moreover, when the secondary cellular telephone is integrated into or is an add-on option, it uses input interfaces of the vehicle such as one or more buttons on the steering wheel or console or dashboard or a touch panel interface of the vehicle. In the case of a plug-in secondary cellular telephone, the secondary cellular telephone may include its own speakers and microphone.

In one embodiment, the secondary telephone can be operated by using the standard controls on the vehicle such as a talk button on the steering wheel or an icon on a touch screen. The user can press a button (a talk button on the steering wheel) to activate the secondary cellular telephone which causes it to register onto the cellular telephone network described herein to otherwise operate as a secondary cellular telephone as described herein. The secondary cellular telephone, when integrated or as an add-on option, can use the vehicle's address book (which contains phone numbers of people or places to call) and can use other features provided by the vehicle such as speech recognition systems that are built into vehicles (to recognize names, places, commands to be performed, etc.).

In one embodiment, the secondary cellular telephone that is part of a vehicle can be configured to be used separately by multiple different users, and each of the users can select their corresponding phone number of their primary cellular telephone to configure the secondary cellular telephone to use their corresponding phone number for spoofing and call forwarding as described herein. Each user can separately configure the secondary cellular telephone by, in one embodiment, entering their password or by speaking in the vehicle. For example, a husband can activate the secondary cellular telephone by entering his password into a touch screen interface in the vehicle so that it spoofs the husband's primary cellular telephone and call forwards from the husband's primary cellular telephone, and when the wife drives the vehicle and needs to activate the secondary cellular telephone, the wife enters her password so that it uses her primary cellular telephone number when spoofing and call forwards calls made to her primary cellular telephone number.

The secondary phone can also have a “find my phone” feature, to identify the location of the primary phone, allow a text message to be sent to the primary phone and/or allow remotely erasing data on the primary phone. Various embodiments illustrating the above mentioned features are described herein.

### BRIEF DESCRIPTION OF THE DRAWINGS

The present invention is illustrated by way of example and not limitation in the figures of the accompanying drawings in which like references indicate similar elements.

FIG. 1 illustrates an embodiment of the primary and the secondary cellular telephones connecting with the cellular telephone network. The cellular telephone network comprises of at least one cellular network server.

FIG. 2 illustrates an embodiment comprising multiple primary and the secondary cellular telephones connecting with the cellular telephone network.

FIG. 3 illustrates embodiments describing the operations of the secondary cellular telephone.

FIG. 4 illustrates embodiments describing the operations of cellular network servers.

FIG. 5 illustrates embodiments describing the spoofing operation for operating the secondary cellular telephone.

FIG. 6 illustrates embodiments describing the call forwarding operation for operating the secondary cellular telephone.

FIG. 7 illustrates embodiments for operating the primary and the secondary cellular telephones connected with the cellular telephone network, describing embodiments of the “find my phone” feature.

FIG. 8 illustrates embodiments for operating the primary and the secondary cellular telephones connected with the cellular telephone network, describing embodiments in which data, in the primary cellular telephone, is remotely erased using the secondary cellular telephone.

FIG. 9 is a block diagram illustrating an exemplary system which may be used in some embodiments of the invention as a secondary cellular telephone.

FIG. 10 is a block diagram illustrating an exemplary computer system which may be used in some embodiments of the invention as a cellular network server.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

### Overview

FIG. 1 illustrates diagram 100 of an embodiment for operating a secondary cellular telephone connected with a cellular telephone network. The secondary cellular telephone described herein can be any one of the embodiments of a cellular telephone described in U.S. Provisional Patent Application No. 61/792,536, filed on Mar. 15, 2013, which is incorporated herein by reference. In another embodiment, the secondary cellular telephone can be part of a vehicle such as an automobile or truck or tractor or motorcycle, etc. The secondary cellular telephone can be either integrated into the vehicle (as delivered from the factory where the vehicle was made) or be an add-on option that is installed by a vehicle dealer (e.g. car dealership) at the time of initial delivery or thereafter. Any one of the embodiments described herein can use such a secondary cellular telephone that is either integrated into the vehicle or is an add-on option. The secondary cellular telephone 102 connects with cellular tower 106 and transmits a cellular registration request which is accepted by cellular network server 108. In any embodiment described herein, the cellular network server 108 can comprise a single server or a plurality of servers. Cellular registration, in this context, is intended to mean (as it is understood by one of ordinary skill in the art) the registration initiated by a mobile device, and/or a cellular telephone network computer server, when a cellular telephone first connects to a cellular telephone network via an Access Point Name (APN). In one embodiment, at least one cellular network server 108 can be an Authentication Center (AuC), as known to one of ordinary skill in the art as a cellular network server to perform authentication of a cellular device during the cellular registration process.

During the cellular registration process, the secondary cellular telephone 102 transmits its identification information to the cellular network server 108. The registration process can include the cellular network server 108 verifying the subscription ID account information for the secondary cellular telephone from subscriber account database(s) 110. The cellular network server 108 queries its subscriber account database(s) 110 to recognize the account information associated with the secondary cellular telephone 102 and the primary cellular telephone 104. Once the cellular network server 108 successfully verifies the authenticity of the secondary cellular telephone 102, the cellular network server 108 transmits a registration accept message and allows the secondary cellular telephone to connect with the cellular telephone network 112. In one embodiment, the registration process (in which the secondary cellular telephone is authenticated and connected to the carrier's cellular telephone network) can be used to automatically (without any user interaction) invoke a set of services such as spoofing or forwarding or both spoofing and forwarding. During this process the cellular network server 108 can also assign a telephone number to the secondary cellular telephone 102, if one is not currently assigned.

In one embodiment, the secondary cellular telephone number can be different from the primary cellular telephone number. In one embodiment, the secondary cellular telephone number can be assigned to the secondary cellular telephone 102 when the user purchases a plan to operate the secondary cellular telephone 102 from the provider or carrier of the cellular telephone network 112. In another embodiment, the secondary cellular telephone number can be permanently assigned to the secondary cellular telephone 102. In another embodiment, the secondary cellular telephone number can be temporarily assigned by the cellular network server 108 for a predetermined period of time. In another embodiment, the temporarily assigned secondary cellular telephone number can be randomly assigned (e.g., from a list of available numbers) by the cellular network server 108. In yet another embodiment, the secondary cellular telephone number can be dynamically assigned each time the cellular network server 108 performs a cellular registration of the secondary cellular telephone.

After successful connection with the cellular telephone network 112, incoming calls at the primary cellular telephone number can be forwarded to the secondary cellular telephone 102 and/or outgoing calls made from the secondary cellular telephone 102 can be spoofed to display the primary cellular telephone number at the caller ID of the call receiving party. In doing so, the call receiving party would not know if the call was initiated using the primary cellular telephone 104 or the secondary cellular telephone 102. These aspects of the present invention are explained in detail while describing FIGS. 3 and 4.

In one embodiment, the cellular registration of the secondary cellular telephone 102, and the connection with the cellular telephone network 112 can be allowed due to a legal contract between the user and the provider or carrier of the cellular telephone network 112. This can be required to comply with government regulations. In one embodiment, information of such an agreement can be stored in the subscriber ID account information (e.g., in database tables). This information can comprise the validity or status of such a contract, the minimum subscriber plan information required for the agreement to remain in effect (e.g., minimum of two cellular telephones are required to activate the agreement), whether call forwarding/spoofing is active, etc. In one embodiment, the subscriber ID account information comprises a ‘spoofing allowed’ flag which indicates that a valid agreement between the user and the provider of the cellular telephone network exists, and that the subscriber has provided permission to allow the secondary telephone to spoof the primary telephone by causing the carrier's cellular telephone network to display the primary telephone's phone number (or other identifier of the primary telephone) as the caller ID of the secondary telephone when the secondary telephone is used to make a telephone call.

FIG. 2 illustrates an embodiment 200 of operating the secondary cellular telephone. This embodiment shows more than one of the secondary cellular telephones connected with the cellular telephone network 212. In this embodiment, the secondary cellular telephones 202A and 204A are associated with the subscriber ID account information of the primary cellular telephones 202B and 204B respectively. The secondary cellular telephones 202A and 204A connect to the cellular network server 208 via one of the cellular tower(s) 206. It should be noted, cellular tower(s) 206 can be one or more cellular towers. Typically, a cellular telephone network will have multiple such towers through which any of the primary and secondary cellular telephones (202A, 202B, 204A, and 204B) can connect to the cellular network server 208 and/or cellular network 212. During cellular registration cellular network server 208 verifies the identification and subscriber ID account information of each the secondary cellular telephone by querying database 210. Once the identification and associated subscriber ID account information is verified, cellular network server 208 connects the secondary cellular telephones 202A and/or 204A to cellular telephone network 212 and the user of each secondary cellular telephone can communicate as if they are using their primary cellular telephone. Furthermore, once the cellular registration process has been completed, the carrier's cellular telephone network can automatically provide (without requiring any instructions or commands from the user of the secondary cellular telephone) the spoofing and/or call forwarding services described herein. In one embodiment, the user can select, in the process of setting up a subscription plan with the carrier, various options such as one or both of: automatic spoofing services each time the secondary cellular telephone is connected to the carrier's cellular telephone network; or automatic call forwarding services each time the secondary cellular telephone is connected to the carrier's cellular telephone network. After setting up the subscription plan, the user, in one embodiment, can deactivate one or both of the services or can decide to activate or deactivate the services on demand. For example, the user of the secondary cellular telephone can decide, either before or after causing the secondary cellular telephone to connect to the cellular telephone network, whether to activate or deactivate one or both call forwarding and spoofing by setting a user preference or command on the secondary telephone.

### Operations by the Secondary Cellular Telephone

FIG. 3 illustrates a flow diagram 300 that shows various embodiments of methods of operating the secondary cellular telephone. In one embodiment, once the secondary cellular telephone is powered on (as represented by block 302), it transmits a cellular registration request to the cellular telephone network (block 306). Further, once the registration process is successful, at block 306, the secondary cellular telephone transmits a request to join the cellular telephone network. The cellular registration process can include verifying/authenticating the mobile device, verifying the subscriber ID account information associated with the secondary cellular telephone, and associating the secondary cellular telephone with the primary cellular telephone number. In one embodiment, the cellular telephone network is configured to automatically forward all incoming calls at the primary cellular telephone number to the secondary cellular telephone once the secondary telephone is connected to the cellular telephone network. Such a configuration, in another embodiment, can be further refined to selectively ring the primary cellular telephone first for a number of rings (e.g., two), before forwarding the incoming call to the secondary cellular telephone. Alternatively, both the primary cellular telephone and the secondary cellular telephone can ring simultaneously so that the user can answer the incoming call from either phone. Yet, in another embodiment, the cellular telephone network is configured to forward incoming calls to the secondary cellular telephone only. In numerous other embodiments, different combinations of the above configurations can be achieved.

In one embodiment, the cellular telephone network's call forwarding configuration can be governed based on an instruction transmitted by the secondary cellular telephone, as shown in block 308. Thus, depending on the instruction transmitted by the secondary cellular telephone (either upon initial connection to the cellular telephone network or at a later time while the connection still exists), the cellular telephone network can apply any of the call forwarding configurations described herein.

The cellular telephone network, in another embodiment, can also be configured to spoof outgoing calls from the secondary cellular telephone with the primary cellular telephone number. This configuration, in one embodiment, can be a result derived, directly or indirectly, from the cellular registration process of the secondary cellular telephone. During spoofing an outgoing call from the secondary cellular telephone displays the primary cellular telephone number on the caller ID of a call receiving party. Thus, the call receiving party would not know if the call was placed from the primary or the secondary cellular telephone.

Alternatively, in another embodiment, the secondary cellular telephone can transmit an instruction to the cellular telephone network to spoof outgoing calls, as shown in block 308. In one embodiment, such an instruction can be transmitted each time an outgoing call is placed from the secondary cellular telephone, providing ad-hoc spoofing. Thus, the user can, each time, choose when to spoof the outgoing call with the primary cellular telephone number and when not to spoof the outgoing call. In another embodiment, the spoofing instruction can be transmitted by the secondary cellular telephone during the cellular registration process. In another embodiment, the forwarding and/or spoofing instruction can be transmitted by the secondary cellular telephone before connecting with the cellular telephone network (thus, after successful cellular registration). In an alternative embodiment, the spoofing instruction transmitted by the secondary cellular telephone can be valid for a predetermined period of time (e.g., two hours) during which the cellular telephone network would allow spoofing the secondary cellular telephone with the primary cellular telephone number for the predetermined period of time.

In other embodiments, any of the above described call forwarding embodiments or the spoofing embodiments by the secondary cellular telephone can also be transmitted by the primary cellular telephone.

Referring back to FIG. 3, if a call is received at the primary cellular telephone number, it can be forwarded to the secondary cellular telephone or additionally to the primary cellular telephone, as shown in blocks 310, 312, and 314. Similarly, once the user places an outgoing call via the secondary cellular telephone, the secondary cellular telephone can be spoofed with the primary cellular telephone number so that the receiver of the call sees the primary cellular telephone number on their caller ID, as shown in blocks 316, 318, and 320.

### Operations by a Cellular Telephone Network Server

FIG. 4 displays a flow diagram 400 which represents embodiments of a cellular network server side flow process which can occur during the operation of the secondary cellular telephone. In one embodiment, at block 402 the cellular network server receives a request to register the secondary cellular telephone. At block 406 the cellular network server queries the subscriber ID account information database and associates the secondary cellular telephone information with that of the primary cellular telephone and the primary cellular telephone number. In an embodiment where the secondary cellular telephone is assigned a permanent the secondary cellular telephone number, the secondary cellular telephone number can also be used to associate with the subscriber ID account information during assignment of the telephone number. In any embodiment, after successful cellular registration, the cellular network server permits the secondary cellular telephone to connect with the cellular telephone network and the secondary cellular telephone becomes active to communicate information, as shown at block 410. In another embodiment, the cellular network server can assign a telephone number to the secondary cellular telephone. This number can be permanently assign during the first time the secondary cellular telephone succeeds with cellular registration, or can be dynamically assigned each time during or after cellular registration, or prior to connecting with the network, as shown at block 408. The secondary cellular telephone number can also be temporarily assigned for a predetermined period of time as discussed elsewhere in this disclosure. As discussed while illustrating FIG. 3, the cellular network server can be configured to automatically forward incoming calls and spoof outgoing calls or can receive these instructions from the secondary cellular telephone (such as in block 412). Regardless of the process of configuring the call forwarding/spoofing features, in various embodiments, at block 414, an incoming call at the primary cellular telephone number can be forwarded to the secondary cellular telephone, the primary cellular telephone, or both the secondary cellular telephone and the primary cellular telephone as shown at blocks 416 and 418.

In various other embodiments, during placement of an outgoing call from the secondary cellular telephone, the cellular network server can be configured to automatically spoof all the secondary cellular telephone outgoing calls with the primary cellular telephone number, or the secondary cellular telephone can instruct the cellular network server when to spoof outgoing calls (block 412) as discussed above in connection with FIG. 3. Various server configurations regarding call forwarding and call spoofing as disclosed above describing FIG. 3 can be implemented by the cellular network server, and are incorporated herein by reference.

At block 420 the cellular network server receives a request to place an outgoing call by the secondary cellular telephone. At block 422, depending on the configuration, the cellular network server can spoof the caller ID of the secondary cellular telephone using the primary cellular telephone number. As described above, in one embodiment, such an instruction can be transmitted by the secondary cellular telephone directly or indirectly during the placement of a call. Corresponding server configurations regarding spoofing the calls as described in connection with FIG. 3 can be implemented in various other embodiments, and are incorporated herein by reference. At block 424, the receiving party's caller ID displays the primary cellular telephone number, and the call receiving party will not be able to determine if the call was made from the primary cellular telephone or the secondary cellular telephone.

### Spoofing Operations

FIG. 5 illustrates the spoofing feature that can be implemented by various embodiments of the secondary cellular telephone and/or cellular network server as represented by diagram 500. The user can place an outgoing call from the secondary cellular telephone (block 502). Identification information required to place the call are transmitted from the secondary cellular telephone 502 to the cellular network server 508. In other embodiments the secondary cellular telephone 502 can transmit an instruction to the cellular network server 508 to spoof the outgoing call as disclosed herein. Upon receiving an outgoing call request cellular network server 508 queries information from the subscriber ID account information and associates the information between the primary cellular telephone and the secondary cellular telephone. This information is represented as block 504 and comprises the subscriber's primary cellular telephone number 506. While spoofing an outgoing call, cellular network server 508 then replaces the caller ID information of the secondary cellular telephone with that of the primary cellular telephone number. Thus, the call receiving party's 510 caller ID displays the primary cellular telephone number as the telephone number of the calling party (or displays another identifier of the primary cellular telephone). The embodiment of FIG. 5 can be combined with the call forwarding features described herein (such as those described in connection with FIGS. 3, 4, and 6).

### Call Forwarding Operations

FIG. 6 illustrates the call forwarding feature that can be implemented by various embodiments of the secondary cellular telephone and/or the cellular network server as represented by diagram 600. In one embodiment, third party caller 602 places a call at the primary cellular telephone number. The cellular network server 604, upon receiving the call, queries a database for the associated data 606 between the primary and the secondary cellular telephones, and based on the associated data 606, which also comprises the subscriber's the secondary cellular telephone number 610, forwards the call to the secondary cellular telephone, as shown at block 612. In another embodiment, cellular network server 604 only forwards incoming calls after it receives an instruction from the secondary cellular telephone. In another embodiment, cellular network server forwards incoming calls to the primary cellular telephone number (block 614) as well so that both the secondary cellular telephone and the primary cellular telephone can ring simultaneously. In another embodiment, the cellular network server can selectively ring one of the primary or the secondary cellular telephone first, before ringing the other cellular telephone. The embodiment of FIG. 6 can be combined with the spoofing features described herein (such as those features described in connection with FIGS. 3, 4, and 5).

### “Find My Phone” Feature of the Secondary Cellular Telephone

FIG. 7 illustrates an embodiment of a secondary cellular telephone having a “find my phone” feature. This feature can be used to request the cellular telephone network to perform one or more configurable actions on the primary cellular telephone 710. As non-limiting examples such configurable actions can include, ringing the primary cellular telephone 710, transmitting the current GPS coordinates of the primary cellular telephone 710 to the secondary cellular telephone 702 or flashing the screen of the primary cellular telephone 710, etc. In one embodiment, a combination of the above configurable actions can be specified in the transmission by the secondary cellular telephone 702. In one embodiment, the “find my phone” feature can be implemented by the secondary cellular telephone in the form of a request instruction transmitted to the cellular network server 708 from the secondary cellular telephone 702 after the user presses a special button, or series of buttons, on the secondary cellular telephone 702. In another embodiment the “find my phone” request instruction is transmitted when the secondary cellular telephone 702 transmits a special code to the cellular network server 706. Each code can instruct the cellular network server 708 to perform certain configurable actions as described herein. Such a code can be key punched by the user using the keypad of the secondary cellular telephone 702. In an alternative embodiment, such an instruction can be voice activated. As a non-limiting example, the user may, as part of the request instruction to the cellular network server, can request GPS coordinates of the primary cellular telephone to be transmitted to the secondary cellular telephone by saying “GPS primary telephone.” In response, the cellular network server can transmit a responsive instruction to the primary cellular telephone, which results in the primary cellular telephone transmitting its coordinates in a text (SMS) message to the secondary cellular telephone.

Referring back to FIG. 7, the secondary cellular telephone 702 transmits a configurable “find my phone” request to cellular network server 708 via cellular tower 704 and cellular telephone network 706. Cellular network server 708, after receiving the configurable “find my phone” request, can perform different configurable instructions (based on the instruction received from the secondary cellular telephone 702) as described above, including transmitting an instruction to the primary cellular telephone 710 (via cellular telephone network 706 and/or cellular tower 705) to transmit an audible notification, so that the user of the secondary cellular telephone 702 can locate the primary cellular telephone 710. The secondary and the primary cellular telephones, 702 and 710 respectively, can be connected to the same cell tower rather than two different ones. In another embodiment, cellular network server 708 transmits an instruction to the primary cellular telephone 710 to send a text message to the secondary cellular telephone 702 with its current GPS coordinates. In another embodiment, the GPS coordinates are transmitted embedded in a link to a map software website (e.g., Google Maps™ mapping service). Alternately, the GPS coordinates can be transmitted via a text message to the secondary cellular telephone 702 in a format which is recognized by a mapping application residing on the secondary cellular telephone 702. In another embodiment, the GPS coordinates are transmitted from the primary cellular telephone 710 to the secondary cellular telephone 702 using the internet. In another embodiment, cellular network server 708 transmits an instruction which causes the screen of the primary cellular telephone 710 to flash for a certain period of time. The above examples are provided as configurable actions that can be performed using the “find my phone” feature and are described herein as non-limiting examples.

### Remote Data Erasing Feature Using the Secondary Cellular Telephone

FIG. 8 illustrates diagram 800 describing embodiments in which data can be remotely erased from the storage memory (e.g., flash memory) of a primary cellular telephone. In one embodiment, the secondary cellular telephone 802 can transmit an erase instruction request to cellular network server 808 (via cellular towers(s) 804 and/or 805) which would result in cellular network server 808 transmitting an erase instruction to the primary cellular telephone 810 to delete data from the storage memory of the primary cellular telephone 810. This feature can be helpful if the user has lost/misplaced the primary cellular telephone 810 or the primary cellular telephone 810 is stolen. In alternative embodiments, this feature can include a request instruction from the secondary cellular telephone 802 to cellular network server 808 to force a cellar deregistration process on the primary cellular telephone 810 so that the primary cellular telephone 810 is inoperable. In one embodiment, the secondary cellular telephone 802 can transmit a request to selectively delete user data (e.g., sensitive personal information) from the primary cellular telephone 810. In another embodiment, the secondary cellular telephone 802 can transmit a request to delete all user data regardless of the sensitivity of the data stored in the storage memory (e.g., flash storage) of the primary cellular telephone 810. In another embodiment, the erase instruction transmitted by cellular network server 808 can delete the operating system and other system files, or alter system data (e.g., operating system, boot loader, embedded code, etc.) to disable the primary cellular telephone 810. The primary and secondary cellular telephones 802 and 810, respectively, can be connected to the same cellular tower rather than separate ones.

### Exemplary Hardware Components of the Secondary Cellular Telephone

FIG. 9 is a block diagram illustrating an exemplary system which may be used in some embodiments of the invention as a secondary cellular telephone. For example, the exemplary architecture of the system 900 may be included in the secondary cellular telephone 102 or any of the other secondary cellular telephones described herein. It should be understood that while FIG. 9 illustrates various components of a computer system, it is not intended to represent any particular architecture or manner of interconnecting the components as such details are not germane to the present invention. It will be appreciated that other cellular telephone systems that have fewer components or more components may also be used with the present invention.

As illustrated in FIG. 9, the system 900, which is a form of a cellular telephone system, includes the bus(es) 901 which are coupled with the processing unit 904, volatile memory 906, and nonvolatile memory 902 (e.g., a hard drive, flash memory, Phase-Change Memory (PCM), etc.). The bus(es) 901 may be connected to each other through various bridges, controllers, and/or adapters as is well known in the art. The processing unit 904 may retrieve instruction(s) from the memory 906 and/or the nonvolatile memory 902, and execute the instructions to perform operations as described above. The processing unit 904 may also receive instructions from the cellular network server(s) via cellular transceiver 908, which can further trigger processing operations utilizing any of the above described components. Bus(es) 901 interconnects the above components together and also interconnects those components to the input/output devices 910 which can include a cursor control device (e.g., a touchscreen), a keyboard, and the other wireless transceiver(s) (e.g., Bluetooth, WiFi, Infrared, GPS, etc.). When the secondary cellular telephone is part of the vehicle (e.g., it is integrated into an automobile at the factory where the automobile is manufactured and assembled), the input/output devices will be part of the vehicle's input and output devices, including the vehicle's one or more microphones, speakers, and control systems such as buttons, touch screens, etc.

### Exemplary Hardware Components of a Cellular Network Server

FIG. 10 is a block diagram illustrating an exemplary server system which may be used in some embodiments of the invention as a cellular network server. The server shown in FIG. 10 can be any one of the cellular network servers described herein such as server(s) 108, server(s) 208, server(s) 508, server(s) 604, server(s) 708, or server(s) 808. Moreover, a server can be a data communication system, that is distributed through an infrastructure of a carrier's cellular telephone network and can be a set of such data communication systems within the infrastructure. For example, the server system 1000 can be a cellular telephone network computer/server. The server system 1000 includes the processing unit 1004, which may include one or more microprocessors and/or a system on an integrated circuit. The processing unit 1004 is coupled with a volatile memory 1010, nonvolatile memory 1002 (e.g., a hard drive, flash memory, Phase-Change Memory (PCM), etc.), network connection from where network data is communicated, as depicted by block 1012, and connection with the subscriber ID account database 1006. In this embodiment, cellular network server 1000 includes the Subscriber ID account database 1006. In other embodiments Subscriber ID account database 1006 can be located in another cellular network server. In any embodiment, a cellular network server refers to a server or a group of servers which are controlled by the provider or carrier of a cellular telephone network. It will be appreciated that additional components, not shown in FIG. 10, may also be a part of the system 1000 in certain embodiments of the invention, and in certain embodiments of the invention fewer components than shown in FIG. 10 may be used. In addition, it will be appreciated that one or more buses, not shown in FIG. 10, may be used to interconnect the various components as is well known in the art.

The volatile memory 1010 and/or non-volatile memory 1002 can store data and/or programs for execution by the computer system 1000. The bus(es) 1001 may be connected to each other through various bridges, controllers, and/or adapters as is well known in the art. The processing unit 1004 can retrieve instruction(s) from the volatile memory 1006 and/or the nonvolatile memory 1002, and execute the instructions to perform operations as described above. The processing unit 1004 may also receive instructions from the primary or the secondary cellular telephones via the cellular telephone network, which can further trigger processing operations utilizing any of the above described components. Bus(es) 1001 interconnects the above components together and also interconnects those components to other input output devices (e.g., NIC (Network Interface Card), a cursor control (e.g., mouse, touchscreen, touchpad, etc.), a keyboard, etc.), and (e.g., Bluetooth, WiFi, Infrared, cellular telephony, GPS, etc.).

The techniques shown in the figures can be implemented using computer program instructions (computer code) and data stored and executed on one or more electronic systems (e.g., computer systems, etc.). Such electronic systems store and communicate (internally and/or with other electronic systems over a network) code and data using machine-readable media, such as machine-readable non-transitory storage media (e.g., magnetic disks; optical disks; random access memory; dynamic random access memory; read only memory; flash memory devices; phase-change memory). In addition, such electronic systems typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

It should be apparent from this description that aspects of the present invention may be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

### Alternative Embodiments of the Secondary Cellular Telephone

Numerous other embodiments and aspects of the secondary cellular telephone are described herein. For example, a user can also have more than one the secondary cellular telephone. For example, a backup phone could be kept in an automobile, while another kept in a bathroom of a home. Each secondary cellular telephone could operate as described above.

In one embodiment described above, the secondary cellular telephone can be integrated into or an add-on option of a vehicle, such as an automobile.

In addition to functioning as a backup or emergency phone, the secondary cellular telephone can be used as an alternative to a large full-featured smartphone. For example, an embodiment of the secondary cellular telephone can be a small, waterproof secondary cellular telephone that can be used during sports, when a large smartphone might be inconvenient to carry or is subject to damage. As non-limiting examples, various aspects and features of the secondary cellular telephone are discussed in provisional Application No. 61/792,536, filed Mar. 15, 2013, which is incorporated in here by reference.

For example, in one embodiment, the secondary cellular telephone can be substantially cylindrical in shape. Yet, other embodiments can include a screw-on mechanism and an O-ring gasket to attach the front surface of the secondary cellular telephone with a back surface; the O-ring gasket provides a good seal against water. Such an embodiment can be waterproof. In one embodiment, the secondary cellular telephone can have an internal frame that defines a substantially cylindrical shape in at least one cross sectional volume through the frame inside the secondary cellular telephone, and a screw-on mechanism can be implemented in that portion of the frame; the secondary cellular telephone can have an external cylindrical shape or can have a different external shape (e.g., rectangular) but still use such a screw-on mechanism. A secondary cellular telephone which uses a screw on mechanism can include (1) a front portion which includes a display on a front surface and includes at least one first screw thread along a first cylindrical wall; and (2) a second portion having a back surface, the second portion having at least a second screw thread along a second cylindrical wall. The second screw thread is designed and sized to match the first screw thread such that the second screw thread matingly screws into the first screw thread. The first screw thread can be a first helical or spiral ridge along the first cylindrical wall and the second screw thread can be a second helical or spiral ridge along the second cylindrical wall. The secondary cellular telephone can also include an O-ring gasket disposed between the first portion and the second portion to seal the joint between these portions and can also be of a water barrier material in one or more regions or surfaces or other joints in order to make the cellular telephone waterproof.

Numerous other embodiments can include other functionality (individually or a combination thereof), such as, being able to communicate with other electronic systems in a low powered mode using a Personal Area Network technology device (e.g., Bluetooth), or having a headset jack to transmit audible sound signals from the cellular telephone device, or having a camera and integrated flash system, Bluetooth, WiFi, near field communication, etc.

In one embodiment the secondary cellular telephone can be a small cylindrical device with a diameter between 2 and 2.5 inches, and a depth (thickness) of 0.2 and 0.5 inches. This embodiment allows the secondary cellular telephone to be comfortably carried in the smallest pant pockets or purse, or worn on the body by attaching it to a wrist strap, armband, lanyard, clip or fastener, yet have a touchscreen large enough to provide a virtual keyboard that allows typing with the same (or almost the same) speed, accuracy, and comfort of smartphones. In one embodiment, the secondary cellular telephone can have a touchscreen display capable of receiving and processing touch inputs where the touch screen display has an exposed diameter between 1.6 inches and 2.2 inches. In one embodiment, the touchscreen display can have a virtual keyboard, including virtual alpha-numeric keys and virtual special keys. In one embodiment, the virtual alpha-numeric keys can have a length between 0.2 inches and 0.27 inches, and width between 0.14 and 0.19 inches. In one embodiment, the virtual alpha-numeric keys can have a horizontal key pitch between 0.18 inches and 0.23 inches and a virtual key pitch between 0.24 inches and 0.36 inches.

In another embodiment, the secondary cellular telephone can also comprise a battery monitoring system, which can monitor the state of the power capacity of a battery in the cellular telephone. The battery monitoring system, upon determining a prescribed state of the power capacity of the battery, and can automatically set the cellular telephone into an active mode (where the cellular transceiver is powered up and the cellular telephone can communicate over a cellular telephone network), and send a notification about the state of the battery to a designated destination using the cellular telephone network, and then return to a low powered mode, or optionally, turn off the secondary cellular telephone after transmission of the notification message.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of operation of a secondary cellular telephone, the method comprising:
transmitting, to a carrier or provider of a cellular telephone network, a request for cellular registration by the secondary cellular telephone, the secondary cellular telephone subscribed to the carrier or provider of the cellular telephone network and is associated with a subscriber identification account of a primary cellular telephone having a primary cellular telephone number, wherein the primary cellular telephone is subscribed with the carrier or provider of the cellular telephone network; and
connecting the secondary cellular telephone with the cellular telephone network, the secondary cellular telephone assigned a secondary telephone number, the secondary telephone number being different from the primary cellular telephone number, and wherein outgoing calls made by the secondary cellular telephone are spoofed with the primary telephone number as the caller ID of the secondary cellular telephone.

2. The method of claim 1, wherein responsive to the request for cellular registration, the secondary cellular telephone receives an acknowledgement of successful cellular registration and is granted access to the cellular telephone network due to an agreement between the user and the carrier or provider of the cellular telephone network, the agreement comprising permission to spoof the primary cellular telephone number as the caller ID of the secondary cellular telephone.

3. The method of claim 1, wherein responsive to connecting the secondary telephone with the cellular telephone network, an incoming call to the primary cellular telephone number is forwarded to the secondary cellular telephone.

4. The method of claim 3, wherein responsive to connecting the secondary telephone with the cellular telephone network, an incoming call at the primary cellular telephone number is further forwarded to the primary cellular telephone so that the call can be answered from either the primary or the secondary cellular telephone.

5. The method of claim 1, further comprising:
transmitting a forwarding instruction to the carrier or provider of the cellular telephone network wherein responsive to the forwarding instruction an incoming call at the primary cellular telephone number is forwarded to the secondary cellular telephone.

6. The method of claim 5, wherein the forwarding instruction is transmitted after connecting the secondary cellular telephone with the cellular telephone network.

7. The method of claim 5, wherein responsive to the forwarding instruction an incoming call is further forwarded to the primary cellular telephone so that the call can be answered from either the primary or the secondary cellular telephone.

8. The method of claim 1, wherein outgoing calls made by the secondary cellular telephone are spoofed with the primary telephone number as the caller ID responsive to a spoofing instruction transmitted by the secondary cellular telephone.

9. The method of claim 8, wherein the spoofing instruction is transmitted after connecting the secondary cellular telephone with the cellular telephone network.

10. The method of claim 8, wherein the spoofing instruction is, directly or indirectly, derived from the placement of an outgoing call.

11. The method of claim 1, wherein the secondary cellular telephone number is a temporary telephone number and is assigned for a limited period of time.

12. The method of claim 11, wherein the temporary telephone number is dynamically assigned each time the secondary cellular telephone transmits a cellular registration request.

13. The method of claim 1, wherein the secondary cellular telephone has a “find my phone” feature for finding the primary cellular telephone.

14. The method of claim 13, wherein the “find my phone” feature causes an audible notification on the primary cellular telephone.

15. The method of claim 13, wherein the “find my phone” feature causes the primary cellular telephone to transmit the coordinates of its present location to the secondary cellular telephone.

16. The method of claim 1, wherein the secondary cellular telephone can transmit an erase instruction to the primary cellular telephone, wherein responsive to the erase instruction, the primary cellular telephone erases data stored in a non-transitory machine readable medium of the primary cellular telephone.

17. The method of claim 16, wherein the erase instruction erases all user data stored in the non-transitory machine readable medium of the primary cellular telephone and the erase instruction instructs the cellular telephone network to render the primary cellular telephone inoperable.

18. A method of operating a secondary cellular telephone by a carrier or provider of a cellular telephone network, the method comprising:
performing a cellular registration of the secondary cellular telephone by a Cellular Network Server (CNS) of the cellular telephone network, the secondary cellular telephone subscribed to the carrier or provider of the cellular telephone network and is associated with a subscriber identification account of the primary cellular telephone having a primary cellular telephone number, wherein the primary cellular telephone is subscribed with the carrier or provider of the cellular telephone network; and
connecting the secondary cellular telephone with the cellular telephone network, the secondary cellular telephone assigned a secondary telephone number, the secondary telephone number being different from the primary cellular telephone number, and wherein outgoing calls made by the secondary cellular telephone are spoofed, by the CNS, with the primary telephone number as the caller ID of the secondary cellular telephone.

19. The method of claim 18, wherein the CNS permits the cellular registration of the secondary cellular telephone after verifying that the subscriber identification account information indicates an agreement between the user and the carrier or provider of the cellular telephone network, the agreement comprising permission to spoof the primary cellular telephone number as the caller ID of the secondary cellular telephone.

20. The method of claim 18, wherein responsive to connecting the secondary telephone with the cellular telephone network, the CNS forwards an incoming call at the primary cellular telephone number to the secondary cellular telephone.

21. The method of claim 20, wherein responsive to connecting the secondary telephone, an incoming call is further forwarded to the primary cellular telephone so that the call can be answered from either the primary or the secondary cellular telephone.

22. The method of claim 18, further comprising:
receiving, by the CNS, a forwarding instruction wherein responsive to the forwarding instruction the CNS forwards an incoming call at the primary cellular telephone number to the secondary cellular telephone.

23. The method of claim 22, wherein the forwarding instruction is received after connecting the secondary cellular telephone with the cellular telephone network.

24. The method of claim 22, wherein responsive to the forwarding instruction, the CNS further forwards an incoming call to the primary cellular telephone so that the call can be answered from either the primary or the secondary cellular telephone.

25. The method of claim 18, wherein outgoing calls made by the secondary cellular telephone are spoofed, by the CNS, with the primary telephone number as the caller ID responsive to a spoofing instruction received by the CNS.

26. The method of claim 25, wherein the spoofing instruction is received after connecting the secondary cellular telephone with the cellular telephone network.

27. The method of claim 25, wherein the spoofing instruction is derived, directly or indirectly, from the placement of an outgoing call by the secondary cellular telephone.

28. The method of claim 18, wherein the secondary cellular telephone number is a temporary telephone number and is assigned, by the CNS, for a limited period of time.

29. The method of claim 28, wherein the temporary telephone number is dynamically assigned, by the CNS, each time during cellular registration of the secondary cellular telephone.

30. The method of claim 18, wherein the CNS receives a “find my phone” instruction from the secondary cellular telephone for finding the primary cellular telephone.

31. The method of claim 30, wherein responsive to the “find my phone” instruction, the CNS transmits an instruction which causes an audible notification on the primary cellular telephone.

32. The method of claim 30, wherein responsive to the “find my phone” instruction, the CNS transmits an instruction to the primary cellular telephone which causes the primary cellular telephone to transmit the coordinates of its present location to the secondary cellular telephone.

33. The method of claim 18, wherein the CNS transmits an erase instruction to the primary cellular telephone, wherein responsive to the erase instruction, the primary cellular telephone erases data stored in a non-transitory machine readable medium of the primary cellular telephone, and wherein the CNS receives the erase instruction from the secondary cellular telephone.

34. The method of claim 33, wherein the erase instruction erases all user data stored in the non-transitory machine readable medium of the primary cellular telephone and in response to the erase instruction the CNS renders the primary cellular telephone inoperable.

35. A secondary cellular telephone comprising:
a transceiver, wherein the transceiver can communicate with a cellular telephone network;
a processing system coupled to the transceiver, wherein the processing system is configured to:
transmit, to a carrier or provider of the cellular telephone network, a request for cellular registration by the secondary cellular telephone, the secondary cellular telephone subscribed to the carrier or provider of the cellular telephone network and is associated with a subscriber identification account of a primary cellular telephone having a primary cellular telephone number, wherein the primary cellular telephone is subscribed with the carrier or provider of the cellular telephone network; and
connect the secondary cellular telephone with the cellular telephone network, the secondary cellular telephone assigned a secondary telephone number, the secondary telephone number being different from the primary cellular telephone number, and wherein outgoing calls made by the secondary cellular telephone are spoofed with the primary telephone number as the caller ID of the secondary cellular telephone.

36. The secondary cellular telephone of claim 35, wherein responsive to the request for cellular registration, the secondary cellular telephone receives an acknowledgement of successful cellular registration and is granted access to the cellular telephone network due to an agreement between the user and the carrier or provider of the cellular telephone network, the agreement comprising permission to spoof the primary cellular telephone number as the caller ID of the secondary cellular telephone.

37. The secondary cellular telephone of claim 35, wherein responsive to connecting the secondary telephone with the cellular telephone network, an incoming call to the primary cellular telephone number is forwarded to the secondary cellular telephone.

38. The secondary cellular telephone of claim 37, wherein responsive to connecting the secondary telephone with the cellular telephone network, an incoming call at the primary cellular telephone number is further forwarded to the primary cellular telephone so that the call can be answered from either the primary or the secondary cellular telephone.

39. The secondary cellular telephone of claim 35, wherein the processing system is further configured to:
transmit a forwarding instruction to the carrier or provider of the cellular telephone network wherein responsive to the forwarding instruction an incoming call at the primary cellular telephone number is forwarded to the secondary cellular telephone.

40. The secondary cellular telephone of claim 39, wherein the forwarding instruction is transmitted after connecting the secondary cellular telephone with the cellular telephone network.

41. The secondary cellular telephone of claim 39, wherein responsive to the forwarding instruction an incoming call is further forwarded to the primary cellular telephone so that the call can be answered from either the primary or the secondary cellular telephone.

42. The secondary cellular telephone of claim 35, wherein outgoing calls made by the secondary cellular telephone are spoofed with the primary telephone number as the caller ID responsive to a spoofing instruction transmitted by the secondary cellular telephone.

43. The secondary cellular telephone of claim 42, wherein the spoofing instruction is transmitted after connecting the secondary cellular telephone with the cellular telephone network.

44. The secondary cellular telephone of claim 42, wherein the spoofing instruction is, directly or indirectly, derived from the placement of an outgoing call.

45. The secondary cellular telephone of claim 35, wherein the secondary cellular telephone number is a temporary telephone number and is assigned for a limited period of time.

46. The secondary cellular telephone of claim 45, wherein the temporary telephone number is dynamically assigned each time the secondary cellular telephone transmits a cellular registration request.

47. The secondary cellular telephone of claim 35, wherein the secondary cellular telephone has a “find my phone” feature for finding the primary cellular telephone.

48. The secondary cellular telephone of claim 47, wherein the “find my phone” feature causes an audible notification on the primary cellular telephone.

49. The secondary cellular telephone of claim 47, wherein the “find my phone” feature causes the primary cellular telephone to transmit the coordinates of its present location to the secondary cellular telephone.

50. The secondary cellular telephone of claim 35, wherein the secondary cellular telephone can transmit an erase instruction to the primary cellular telephone, wherein responsive to the erase instruction, the primary cellular telephone erases data stored in a non-transitory machine readable medium of the primary cellular telephone.

51. The secondary cellular telephone of claim 50, wherein the erase instruction erases all user data stored in the non-transitory machine readable medium of the primary cellular telephone and the erase instruction instructs the cellular telephone network to render the primary cellular telephone inoperable.

52. A non-transitory computer readable medium comprising instructions which, when executed by a processing system of a secondary cellular telephone, perform a method of operation of the secondary cellular telephone, the method comprising:
transmitting, to a carrier or provider of a cellular telephone network, a request for cellular registration by the secondary cellular telephone, the secondary cellular telephone subscribed to the carrier or provider of the cellular telephone network and is associated with a subscriber identification account of a primary cellular telephone having a primary cellular telephone number, wherein the primary cellular telephone is subscribed with the carrier or provider of the cellular telephone network; and
connecting the secondary cellular telephone with the cellular telephone network, the secondary cellular telephone assigned a secondary telephone number, the secondary telephone number being different from the primary cellular telephone number, and wherein outgoing calls made by the secondary cellular telephone are spoofed with the primary telephone number as the caller ID of the secondary cellular telephone.

53. A non-transitory computer readable medium comprising instructions which, when executed by a processing system of a Cellular Network Server (CNS) of a cellular telephone network, perform a method of operating a secondary cellular telephone by a carrier or provider of the cellular telephone network, the method comprising:
performing a cellular registration of the secondary cellular telephone by the CNS, the secondary cellular telephone subscribed to the carrier or provider of the cellular telephone network and is associated with a subscriber identification account of the primary cellular telephone having a primary cellular telephone number, wherein the primary cellular telephone is subscribed with the carrier or provider of the cellular telephone network; and
connecting the secondary cellular telephone with the cellular telephone network, the secondary cellular telephone assigned a secondary telephone number, the secondary telephone number being different from the primary cellular telephone number, and wherein outgoing calls made by the secondary cellular telephone are spoofed, by the CNS, with the primary telephone number as the caller ID of the secondary cellular telephone.

54. The method as in claim 1 wherein the secondary cellular telephone is either integrated into a vehicle or is an add-on option of the vehicle or is a plug-in capability of the vehicle.

55. The method as in claim 54 wherein the secondary cellular telephone in the vehicle is configured to be used by multiple users and each of the users can select their corresponding phone number of their primary cellular telephone to configure the secondary cellular telephone to use their corresponding phone number for spoofing and call forwarding.

56. The method as in claim 55 wherein the secondary cellular telephone is integrated into the vehicle at a factory location where the vehicle is manufactured and wherein the secondary cellular telephone is configured by a user's entry of a password or by the user's spoken voice which is recognized by a speech recognition system in the vehicle, and wherein the speakers and microphone are integrated into the vehicle.
